(19) United States
(12) Patent Application Publication
(10) Pub. No.: US 2007/0020980 A1
(43) Pub. Date: Jan. 25, 2007

(54) Electrical connection apparatus

(76) Inventor: Gregory Lawrence Seibert, Bethel, OH (US)

Correspondence Address: MILACRON INC., 2090 FLORENCE AVE., CINCINNATI, OH, 45206, US

(21) Appl. No.: 11/188,484

(22) Filed: Jul. 25, 2005

(51) Int. Cl. H01R 13/64

(52) U.S. Cl. 439/248

(57) ABSTRACT

A connector assembly for connecting machine devices with input/output interface circuits of a machine control. Each machine device is connected to the connector assembly by a machine device signal conductor and a common conductor for carrying a power supply value. Each input/output interface circuit is connected to the connector assembly by a control interface conductor for carrying a machine device signal. The connector assembly comprises a substrate, at least one machine device connector half mounted thereon for connection with machine device signal conductors and common conductors, and at least one control interface connector half mounted to the substrate for connection with machine interface conductors. Each connector half has contact elements for engagement with mating contact elements of a mating connector half, and the connector assembly comprises conductors for interconnecting contact elements of each machine device conductor half connected to common conductors to be connected to the same power supply value.

### I. BACKGROUND OF THE INVENTION

1. Field of the Invention

This invention relates generally to electrical interconnection of machine devices with machine control devices. In particular, this invention relates to connector assemblies providing interconnection of conductors.

2. Description of Related Art

It is common for electrical devices comprising machines and associated equipment to be connected to control devices by pairs of conductors, one conductor of each pair providing a connection for a power supply value, for example a direct current voltage or reference value applied to the machine device, and the other conductor providing a connection for a signal transmitted to or from the machine device. The use of two conductors insures that a complete electrical circuit is made between the machine device and the connected control device. It is also common for sets of machine conductors to be connected through connectors to a single control module providing plural machine device interface circuits. At such control units, a single termination is provided for each power supply value to be connected to the machine devices irrespective of the number of machine device interface circuits resident on the control module. Consequently, it is necessary to interconnect conductors from machine devices to effect connection to the terminations for power supply values at the control devices, the interconnections commonly being made by jumper wires or the like at connectors used to connect the machine device conductors to the control modules. As these jumpers are typically fabricated as needed, they increase the time required for wiring machines and increase the potential for wiring errors where jumpers improperly interconnect conductors. Hence there is a need to improve the manner of interconnecting power supply values for machine wiring to eliminate the need for use of jumpers and the like at connectors terminating machine device conductors for connection to control modules.

### SUMMARY OF THE INVENTION

It is an object of the present invention to provide a connector assembly comprising a substrate with connector halves mounted thereon for connecting conductors connected to machine devices with conductors connected to control devices and wherein conductors connected to machine devices and conducting a power supply value thereto are interconnected and connected to the power supply value.

Further objects and advantages of the invention shall be made apparent from the accompanying drawings and the following description thereof.

In accordance with the aforesaid objects the present invention provides a connector assembly for electrically connecting devices of a machine with devices of a machine control, each machine device being connected to the connector assembly with at least one machine device signal conductor for carrying a signal and at least one common conductor for carrying a power supply value, input/output interface circuits of the machine control being connected to the connector assembly by control interface conductors for carrying machine device signals, the connector assembly comprising a substrate, at least one machine device connector half mounted to the substrate for connection with machine device signal conductors and machine device common conductors and at least one control interface connector half mounted to the substrate for connection with control interface conductors, each connector half having contact elements for engagement with mating contact elements of a mating connector half, and conductors for interconnecting contact elements of each machine device conductor half connected to common conductors to be connected to the same power supply value. Advantageously, the power supply value is available through a contact element of a control interface connector and the interconnected contact elements of the machine device connector are connected to the contact element of the control interface connector that is connected to the power supply value.

### BRIEF DESCRIPTION OF THE DRAWINGS

FIG. 1 illustrates an injection molding machine and control and interconnection of machine devices with control elements

FIG. 2 is a schematic diagram of electrical connections in accordance with the invention.

FIG. 3 is a three dimensional view of a connector assembly in accordance with the invention.

### DETAILED DESCRIPTION OF THE PREFERRED EMBODIMENT

The invention shall be illustrated with reference to a preferred embodiment which shall be described in detail. It is not the intention of applicant that the invention be limited to the preferred embodiment, but rather that the invention shall be defined by the appended claims and all equivalents thereof.

Plastics Processing Machine & Equipment

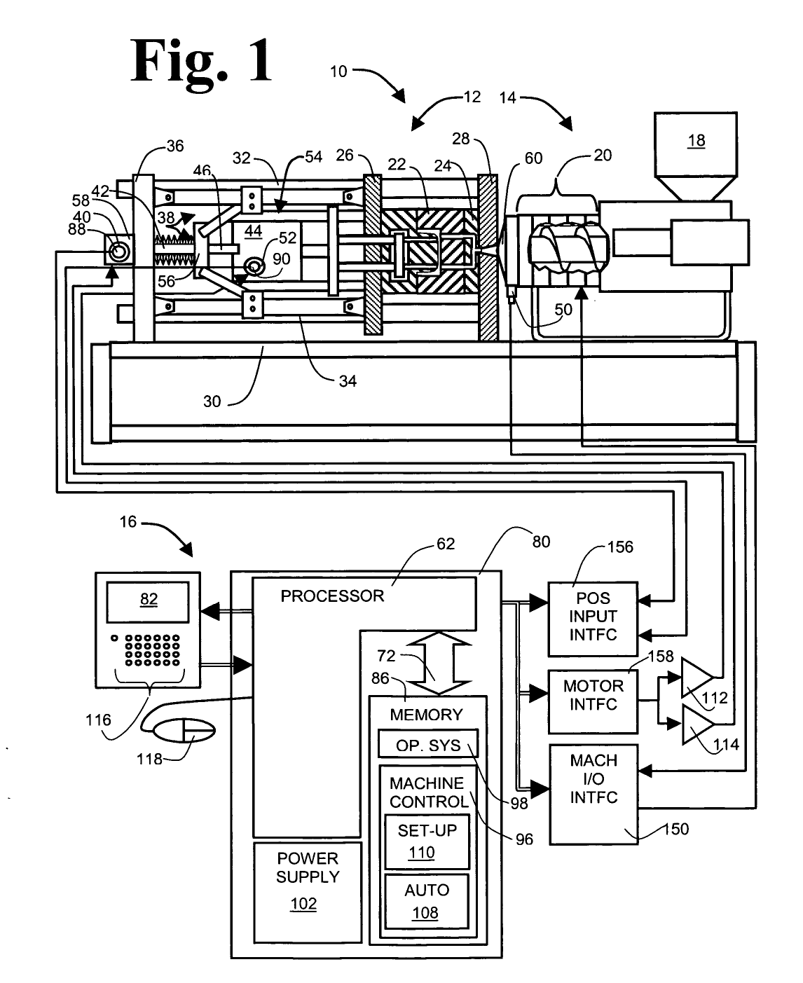

Referring to FIG. 1, an injection molding machine 10 includes a clamp assembly 12 and an injection unit 14. Typical of plastic injection molding machines, raw material in the form of pellets and/or powders is introduced to injection unit 14 through hopper 18. Injection unit 14 includes a barrel portion 60, typically surrounded by external heating elements 20, and an internal material working screw shown in the cutaway of injection unit 14. As raw material is melted, i.e. plasticized, by a combination of heating and material working, the plasticized material is conveyed toward the exit end of injection unit 14, displacing the interior screw away from clamp assembly 12. Once a sufficient volume of material has been plasticized, the working screw is advanced within barrel portion 60 to force material through the exit into a cavity defined by mating mold sections 22 and 24. Clamp assembly 12 holds mold sections 22 and 24 together during injection and thereafter until the injected material has sufficiently solidified to be removed without unacceptable deformation. Movable platen 26 is then retracted, separating mold section 22 from mold section 24 to permit release of the molded article.

Continuing with reference to FIG. 1, clamp assembly 12 comprises fixed platen 28, movable platen 26, thrust or “die height” platen 36 and toggle link mechanism 38. Fixed platen 28 supports mold section 24 and is rigidly mounted to machine base 30. Strain rod pairs 32 and 34 are supported at opposite ends by fixed platen 28 and thrust or die height platen 36. Movable platen 26 is slidably supported on strain rod pairs 32 and 34 for reciprocation between “open” and “closed” positions, “closed” referring to the advanced position as shown in FIG. 1. A toggle link mechanism 38, interposed between movable platen 26 and thrust platen 36, is operated by a rack and pinion combination comprising a rack 42 and pinion (not shown) within drive case 58. The pinion is rotated by motor 40 to translate rack 42 horizontally toward and away from fixed platen 28. Rack 42 is connected with a toggle link crosshead 56. Alternatively, reciprocation of toggle link crosshead 56 may be effected by other known actuators including motor driven low friction screw and nut combination or hydraulically operated actuators. Toggle link mechanism 38 is preferably operable to a “lock-over” configuration, as shown in FIG. 1 wherein serial pivoting links between thrust platen 36 and movable platen 26 are longitudinally aligned. On opening, reciprocation of crosshead 56 pivots these links to reduce the effective length spanned by the links and draw movable platen 26 away from fixed platen 28.

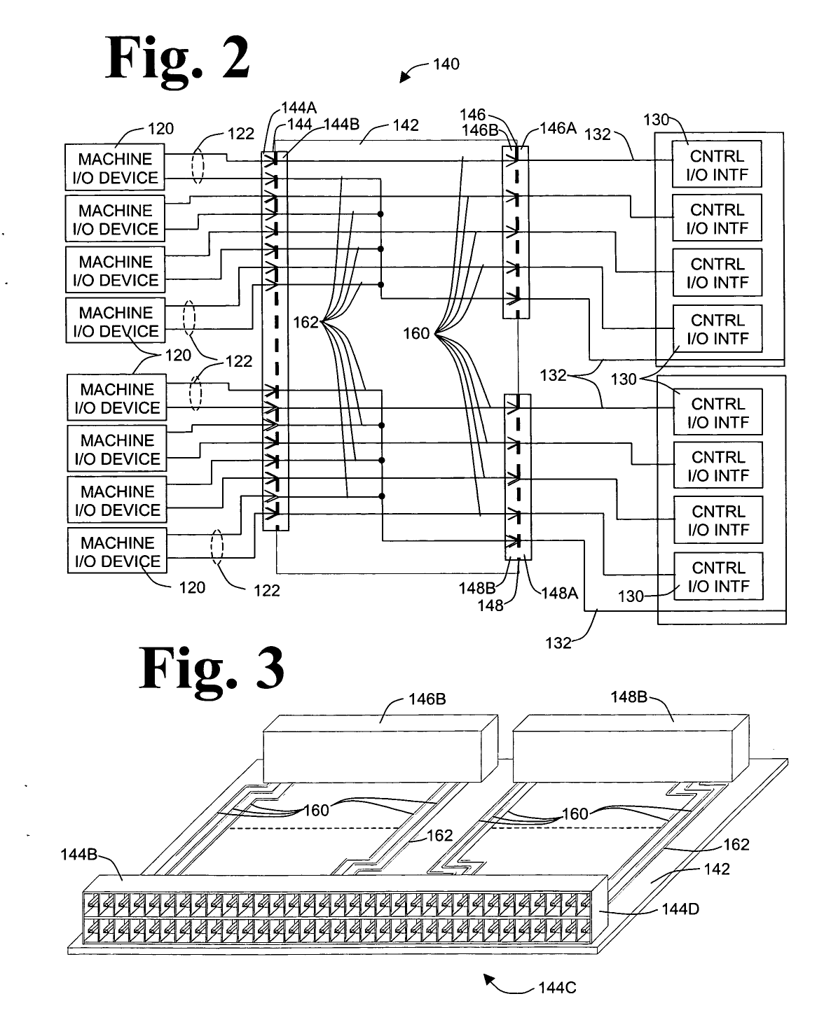

As is conventional, motor 40 is preferably a servo-motor and includes or works in combination with a position measuring transducer 88 which produces electrical signals representing position of the motor armature. In the configuration illustrated in FIG. 2, position transducer 88 may be an encoder for measuring angular position of an armature of motor 40. Were motor 40 a linear motor, position transducer 88 could as well measure linear position of the motor armature. Alternatively, position transducer 88 may measure linear displacement and be mechanically coupled to crosshead 56.

Continuing with reference to FIG. 1, a power operated ejector mechanism 54 is illustrated in FIG. 1 disposed between thrust platen 36 and movable platen 26. Ejector mechanism 54 effects translation of movable members in mold section 22 to dislodge an article from mold section 22. Motor 52 provides motive force for ejector mechanism 54 through transmission 44. Motor 52 is mounted to and supported by transmission 44 which is fixably supported by movable platen 26 so that transmission 44 and motor 52 move with movable platen 26.

As shown in FIG. 1, motor 52 is a rotating machine, wherein an armature and stator are arranged for rotation of one relative to the other. As is conventional, motor 52 is preferably a servo-motor and includes or works in combination with a position measuring transducer 90 which measures relative angular position. Also, as is well known for control of servo motors, other transducers may be used with motor 52 to measure, for example, angular velocity or to detect motor element relative locations for motor current commutation. Transmission 44 converts rotation of the armature of motor 52 to translation for reciprocation of ejector pins in mold section 22. The motion conversion of transmission 44 and the operation of transducer 90 are such that position of an armature of ejector mechanism 54 within its range of translatory motion can be unambiguously determined from measurement of angular position by position transducer 90. In the configuration illustrated in FIG. 1, position transducer 90 may be an angular position encoder.

Control

The preferred embodiment of a machine control system comprises an “open architecture” personal computer. By virtue of the standardized manner software and hardware can be installed in so called open architecture environments, mechanism control functions implemented as proprietary programs can be supplied to effect machine control at substantially less cost than can be achieved using low volume and/or proprietary environments. Control system 16 comprises computer system 80 comprising a memory 86, and a primary processor assembly 62, a display device 82, keyboard 116, and a pointing device 118 such as a “mouse”. Advantageously, memory 86 may comprise a disk memory, advantageously a magnetic disk memory wherein local processing facilities control mechanisms for positioning the read/write elements relative the storage media.

As is conventional, data processing functions performed by computer system 80 are controlled by operating system programs 98 controlling execution of “application” programs such as machine control programs 96. Machine control 16 produces signals for controlling the operation of machine devices, such as motors 40 and 52 which actuate mechanisms of the injection molding machine, heaters 20 and other devices not shown but typical of such machines and associated equipment. Output signals defining, for example, position, velocity, and/or acceleration are conditioned as appropriate at motor interface circuits 158 and applied to motor drives 112 and 114 to control electrical current delivered to motors 40 and 52 from a suitable power source. As is conventional, signals produced by position transducers 88 and 90 are used for control of motors 40 and 52. Outputs of transducers 88 and 90 are conditioned for use by computer system 80 by position transducer interface circuits 156. Machine input/output interface circuits 150 perform signal conditioning for signals produced by or applied to machine devices including without limitation electrical heating elements, mechanically operated switches, solenoids, relays, proximity sensors, temperature sensors and pressure sensors. Machine input/output circuits 150 are advantageously arranged on modules comprising plural interface circuits of like kind. For example, interface circuits for alternating current circuits are arranged on separate modules from interface circuits for direct current circuits and interface circuits for switching devices are arranged on separate modules from interface circuits for sensors providing continuous signals. Interface circuit modules are advantageously arranged for connection to primary processor assembly 62 by a signal bus for transferring digital data between processor assembly 62 and interface circuits 150. Connections between machine input/output interface circuits 150 and machine devices are advantageously made using connectors terminating conductors connected to the machine devices for ease of connection to the modules comprising the input/output interface circuits.

Power supply 102 converts power applied thereto to various operating values used by the components of machine control 16, including computer system 80 and machine electrical devices, by machine input and output interface circuits 150, by position transducer interface circuits 156 and motor interface circuits 158. Power supply 102 advantageously provides positive and negative low level direct current values as appropriate for the machine devices and interface circuits.

Referring to FIG. 2, machine input and output devices 120 are illustrated schematically as electrically connected by conductor pairs such as conductor pair 122 comprising a machine device signal conductor carrying a machine device input or output signal and a common conductor carrying a power supply value. Each machine device 120 may be a source for a signal, the signal referred to as an output of the machine device, or may receive a signal, the signal referred to as an input to the machine device. The power supply value may be, for example, an alternating current value, a direct current value, or ground. Conductor pairs 122 from the machine devices 120 are terminated at connector half 144A comprising machine device connector 144. Machine device input and output signals are carried from mating connector half 144B via conductors 160 of connector assembly 140 to connector halves 146B and 148B comprising connectors 146 and 148, respectively. For each machine device input or output, a suitable input/output interface circuit 130 is provided comprising a module of machine input and output interface circuits 150. Input/output interface circuits 130 commonly provide isolation between the machine device signal levels and signal levels used by components of processor 62. Control interface connector halves 146A and 148A provide connections from conductors 160 of connector assembly 140 to control interface conductors 132 terminated at input/output interface circuits 130. Connector halves 144B, 146B and 148B are advantageously affixed to substrate 142 (see FIG. 3). Mating connector halves 144A, 146A and 148A advantageously comprise wiring harnesses together with conductor pairs 122 and conductors 132, respectively. As is conventional, each of mating connector halves 144A and 144B, 146A and 146B and 148A and 148B comprise contact elements for mating engagement with contact elements of the mating connector half. In accordance with the invention, conductors 162 of connector assembly 140 interconnect terminations of machine device common conductors of conductor pairs 122 at connector 144 and permit connection thereof to the appropriate power supply values via connectors 146 and 148. Hence, common conductors that will be connected to the same power supply values are interconnected by conductors of the connector assembly. Conductors for power supply values comprise wiring harnesses comprising connector halves 146A and 148A, the conductors advantageously being connected to power supply values at the modules comprising input/output interface circuits 130.

Referring to FIG. 3, connector halves 144B, 146B and 148B are shown mounted on substrate 142. Each of connector halves 144B, 146B and 148B provide a set of terminations for conductors of connector assembly 140. Substrate 142 is advantageously a printed circuit board of conventional construction, conductors 160 and 162 comprising plated conductors adhered to an insulating substrate material and making electrical connection with contact elements of connector halves 144B, 146B and 148B. Contact elements 144C of connector half 144B are seen within connector body 144D. Mating contact elements (not shown) comprise connector half 144A, the contact elements 144C and mating contact elements being brought together with mating engagement of connector halves 144A and 144B. In similar fashion, contact elements in each of connector halves 146B and 148B are brought together with mating contact elements of connector halves 146A and 148A, respectively. With mating connector halves joined, individual machine device signal conductors of machine device conductor pairs 122 are electrically connected with individual control interface conductors of control interface conductors 132 and common machine device conductors of machine device conductor pairs 122 are interconnected and connected to the desired power supply values.

What is claimed is:

1. A connector assembly for electrically connecting devices of a machine with devices of a machine control, each machine device being connected to the connector assembly with at least one machine device signal conductor for carrying a signal and at least one common conductor for carrying a power supply value, input/output interface circuits of the machine control being connected to the connector assembly by control interface conductors for carrying machine device signals, the connector assembly comprising a substrate, at least one machine device connector half mounted to the substrate for connection with machine device signal conductors and machine device common conductors and at least one control interface connector half mounted to the substrate for connection with control interface conductors, each connector half having contact elements for engagement with mating contact elements of a mating connector half, and conductors for interconnecting contact elements of each machine device conductor half connected to common conductors to be connected to the same power supply value.

2. The connector assembly according to claim 1 further comprising a conductor connecting interconnected contact elements of the machine device connector half to at least one contact element of a control interface connector half.

3. The connector assembly according to claim 2 wherein there are at least two control interface connector halves and the connector assembly further comprises a first conductor connecting a first plurality of interconnected contact elements of the machine device connector half to at least one contact element of a first control interface connector half and a second conductor connecting a second plurality of interconnected contact elements of the machine device connector half to at least one contact element of a second control interface connector half.

4. The connector assembly according to claim 3 wherein the first conductor connects to contact elements of the first control interface connector half that are to be connected to a first power supply value and the second conductor connects to contact elements of the second control interface connector half that are to be connected to a second power supply value different from the first power supply value.
